(19) United States
(12) Patent Application Publication
(10) Pub. No.: US 2010/0124829 A1
(43) Pub. Date: May 20, 2010

(54) ELECTRICAL CONNECTOR WITH A PRINTED CIRCUIT BOARD MOUNTED THEREON

(75) Inventors: JIA-YONG HE, Kunshan (CN); QI-SHENG ZHENG, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/619,693

(22) Filed: Nov. 17, 2009

(30) Foreign Application Priority Data
Nov. 17, 2008 (CN) 200810305583.3
Nov. 17, 2008 (CN) 200810305584.8
Nov. 21, 2008 (CN) 200820302872.3

(51) Int. Cl. H01R 12/00

(52) U.S. Cl. 439/76.1

(57) ABSTRACT

An electrical connector to be mounted on an outer printed circuit board, includes a receiving cavity to accommodate a mating plug and an insulative housing having a lower cover which is provided with a rear base portion. An inner printed circuit board is mounted onto the base portion and extending into the receiving cavity, and including a number of first contacting pads on a front side thereof to be exposed to the receiving cavity and a number of second contacting pads electrically connected to the first contacting pads respectively, the second contacting pads is to be electrically connected to the outer printed circuit board. A number of contacts are mounted to the second contacting pads respectively and to be mounted the outer printed circuit board. A metal shell is mounted onto the housing to enclose the insulative housing and the inner printed circuit board to form the receiving cavity, the metal shell is spaced apart from the inner printed circuit board.

### BACKGROUND OF THE INVENTION

1. Field of the Invention

The present invention relates to electrical connectors, more particularly to electrical connectors with a printed circuit board mounted thereon.

2. Description of Related Art

HDMI (High-Definition Multimedia Interface) is a compact audio/video interface for transmitting uncompressed digital data. HDMI is widely adopted on digital audio/video sources—such as set-top boxes, Blue-ray Disc players, personal computers (PCs), video game consoles, computer monitors, and digital televisions. The constant development of HDMI is standardized by the HDMI Founders which include Hitachi, Panasonic, Philips, Silicon Image, Sony, Thomson, and Toshiba. The initial version of HDMI specification (HDMI 1.0) was released on Dec. 9, 2002. The latest version of HDMI specification is HDMI 1.4 which was released on Jun. 5, 2009.

In the specification of HDMI 1.4, five types (Type A, B, C, D, E) of HDMI receptacle are defined. A HDMI receptacle typically includes an insulative housing, a plurality of electrical contacts mounted thereon and a metal shell enclosing the insulative housing and the contacts to form a plug receiving cavity. The housing defines a rear base portion and a front tongue portion extending integrally and forwardly from the base portion, the contacts each is provided with a contacting portion mounted on the tongue portion to be exposed to the receiving cavity. The contacting portions are arranged in two parallel flat planes, it is laborious to form passageways on the front tongue and insert the contacting portions to corresponding passageways on the tongue portion precisely and to detect a final position of the contacting portions.

As discussed above, there is a need to design an improved electrical connectors.

### SUMMARY OF THE INVENTION

According one aspect of the present invention, an electrical connector to be mounted on an outer printed circuit board, comprising: a receiving cavity to accommodate a mating plug; an insulative housing including a lower cover which is provided with a rear base portion; an inner printed circuit board being mounted onto the base portion and extending into the receiving cavity, and including a plurality of first contacting pads on a front side thereof to be exposed to the receiving cavity and a plurality of second contacting pads electrically connected to the first contacting pads respectively, the second contacting pads is to be electrically connected to the outer printed circuit board; a plurality of contacts mounted to the second contacting pads respectively and to be mounted the outer printed circuit board; a metal shell mounted onto the housing to enclose the insulative housing and the inner printed circuit board to form the receiving cavity, the metal shell being spaced apart from the inner printed circuit board.

According to another aspect of the present invention, an electrical connector to be mounted on an outer printed circuit board, comprising: a receiving cavity to accommodate a mating plug; an insulative housing including a rear base portion; an inner printed circuit board mounted onto the base portion, and including an upper face, a lower face opposite to the upper face, a plurality of first contacting pads on a front side thereof to be exposed to the receiving cavity and a plurality of second contacting pads electrically connected to the first contacting pads respectively, the first contacting pads are arranged in an upper row on the upper face and a lower row on the lower face, the second contacting pads are arranged merely on the lower face; a plurality of contacts mounted to the second contacting pads respectively and to be mounted the outer printed circuit board.

Other objects, advantages and novel features of the present invention will become more apparent from the following detailed description of the present embodiment when taken in conjunction with the accompanying drawings.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an electrical connector according to a first preferred embodiment of the present invention;

FIG. 2 is a view similar to FIG. 1, while taken from a different aspect;

FIG. 3 is an assembled view of an inner printed circuit board and a lower cover of the electrical connector;

FIG. 4 is an exploded view of the electrical connector shown in FIG. 1;

FIG. 5 is a view similar to FIG. 4, while taken from a different aspect;

FIG. 6 is a perspective view of an electrical connector according to a second embodiment of the present invention;

FIG. 7 is an exploded view of the electrical connector shown in FIG. 6;

FIG. 8 is a view similar to FIG. 7, while taken from a different aspect;

FIG. 9 is a view similar to FIG. 8, while taken from a different aspect;

FIG. 10 is an assembled view of a lower cover, a plurality of contact module of the electrical connector shown in FIG. 6; and

FIG. 11 is a perspective view of an electrical connector according to a third embodiment of the present invention;

FIG. 12 is an partially exploded view of the electrical connector shown in FIG. 11;

FIG. 13 is a view similar to FIG. 12, while taken from a different aspect;

FIG. 14 is an exploded perspective view of the electrical connector shown in FIG. 11; and

FIG. 15 is a view similar to FIG. 14, while taken from a different aspect.

### DETAILED DESCRIPTION OF THE INVENTION

Reference will be made to the drawing figures to describe the present invention in detail, wherein depicted elements are not necessarily shown to scale and wherein like or similar elements are designated by same or similar reference numeral through the several views and same or similar terminology.

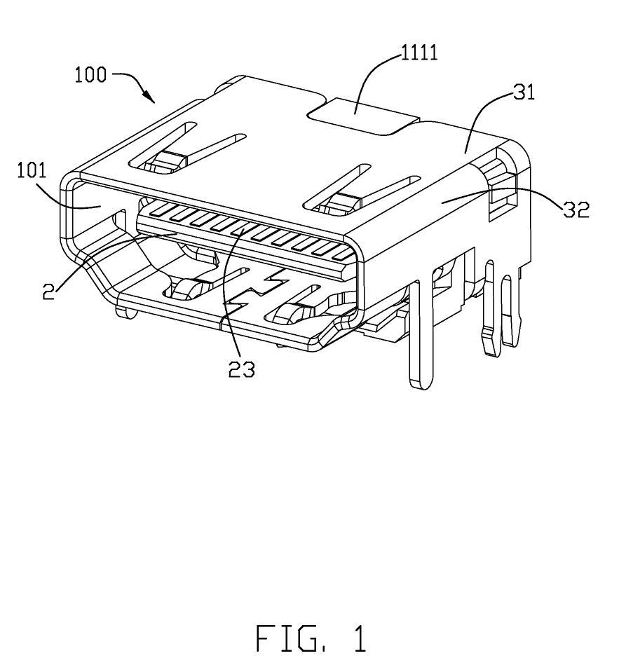

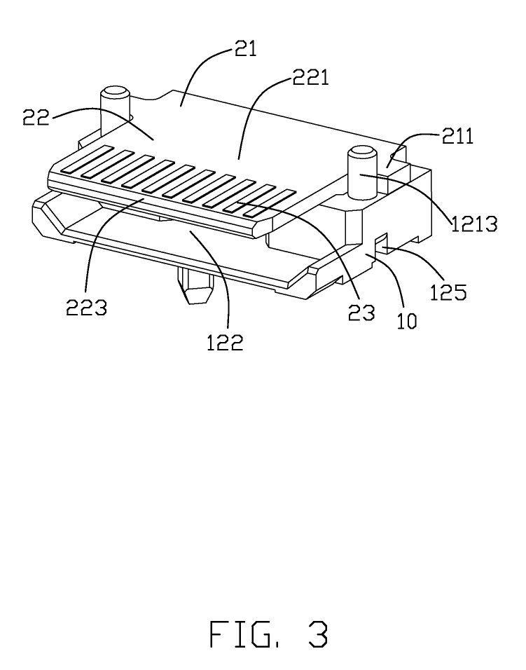

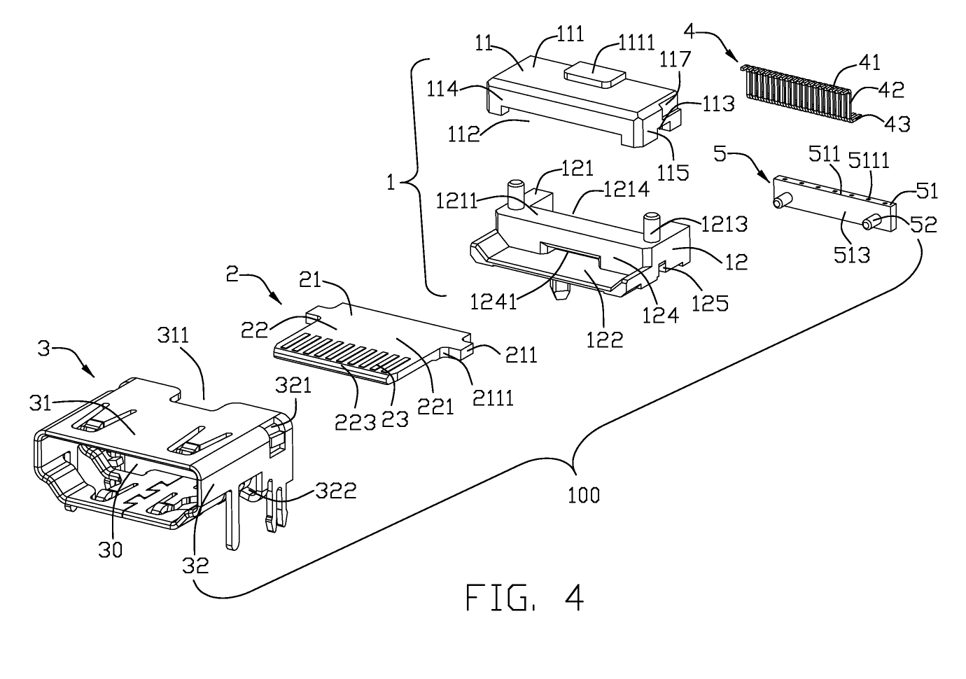

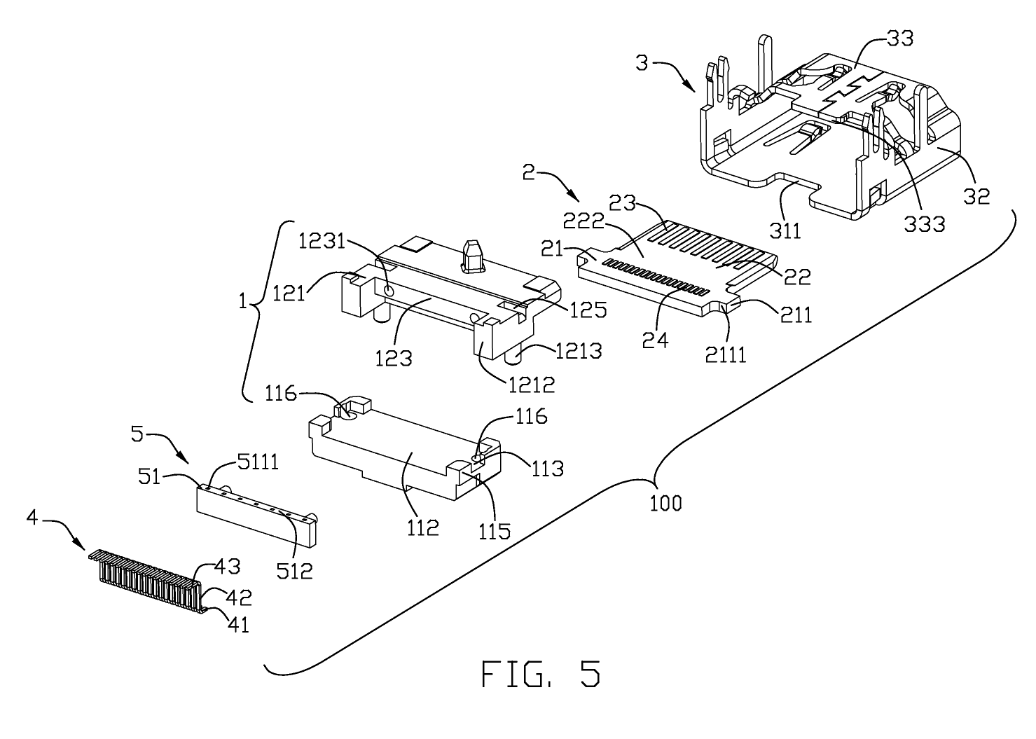

Referring to FIGS. 1-5, an electrical connector of the preferred embodiment is a HDMI A-type receptacle 100 to mate with a mating plug which is a HDMI A-type plug. The electrical receptacle 100 is surface mounted on an outer printed circuit board (PCB) and includes an insulative housing 1, an inner printed circuit board 2 fixed onto the housing 1 to contact with the mating plug, a plurality of contacts 4 connected to the inner printed circuit board 2 and a metal shell 3 attached to the housing 1. The metal shell 3 encloses the housing 1 and the inner printed circuit board 2 to form a receiving cavity 101 to accommodate the mating plug.

The insulative housing 1 including a lower cover 10 and an upper cover 11 attached to the lower cover 10. The lower cover 10 defines a main portion 12 having a supporting face 1211 on a top side thereof to support the inner printed circuit board 2. A pair of first posts 1213 extend vertically and upwardly from the supporting face 1211, and the upper cover 11 is provided with a pair of first holes 116 on a bottom side thereof to retain the first posts 1213 respectively. A pair of arm portions 121 extend rearward from a rear face 123 of the main portion 12, the arm portions 121 are spaced apart from each other along a transverse direction of the housing 1 to define a receiving space 1214 therebetween, a spacer 5 is disposed in the receiving space 1214 to position the contacts 4.

The inner printed circuit board 2 is sandwiched between the upper cover 11 and the lower cover 10, and includes a plurality of first contacting pads 23 on a front side thereof to be exposed to the receiving cavity 101 and a plurality of second contacting pads 24 electrically connected to the first contacting pads 23 respectively, the second contacting pads 24 is to be electrically connected to the outer printed circuit board via the contacts 4. The first contacting pads 23 are arranged in two rows which are located on an upper face and a lower face of a front portion of the inner printed circuit board 2. The second contacting pads 24 are placed in one row on the lower face of a rear portion of the inner printed circuit board 2.

The spacer 5 defines a vertical plate 51 and a pair of second posts 52 extending forwardly from a front face 513 of the vertical plate 51, a pair of second holes 1231 are recessed forwardly from the rear face 123 to secure the second posts 52 respectively. The contacts 4 are arranged in one row and each includes an upper mating portion 43 to be connected to the corresponding second contacting pad 24, a soldering portion 41 to be surface mounted to the outer printed circuit board and a body portion 42 interconnecting the mating portion 43 and the soldering portion 41. The spacer 5 defines a number of through holes 5111 to retain the body portions 42 respectively.

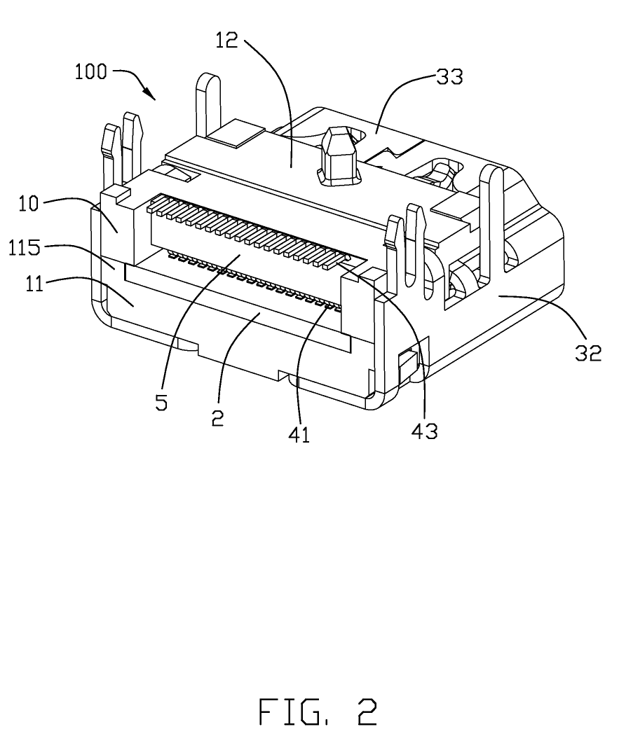

The inner printed circuit board 2 includes a rectangular portion 22 with the first contacting pads 23 and the second contacting pads 24 formed thereon, and a pair of ribs 211 projecting laterally and outward from opposite sides of the rectangular portion 22. The ribs 211 each defines an abutting face 2111 in a front side thereof to abut against the first post 1213. The upper cover 11 has a hollow 113 on a bottom side thereof to lock with the rib 211, thereby preventing the inner printed circuit board 2 moving along a front-to-rear direction. Referring to FIG. 2, the inner printed circuit board 2 is retained between the upper cover 11 and the lower cover 10 along a height direction of the housing 1. The upper cover 11 includes a pair of raised portions 115 spaced apart from each to form a slot 112 therebetween, the slot 112 extends through the upper cover 11 along a front-to-rear direction, the rectangular portion 22 of the inner printed circuit board 2 is received in the slot 112 and sandwiched between the raised portions 115.

The metal shell 3 includes a top wall 31, a bottom wall 33 opposite to the top wall 31, and a pair of side walls 32 connected to the top wall 31 and the bottom wall 33. The metal shell 3 is spaced apart from the inner printed circuit board 2. A cutout 311 is provided on the top wall 31 of the shell 3, and a protrusion 1111 extends upward from an upper wall 111 of the upper cover 11 to be retained within the cutout 311. The bottom wall 33 defines a projection 333 extending rearward to be fixed in a slot 1241 recessed rearward from a vertical stopping face 124 of the base portion 12, the stopping face 124 is adopted to abut against a front end of the mating plug to determine a insertion depth of the mating plug, the first contacting pads 23 are arranged in a front side of the stopping face 124, the second contacting pads 24 are located on a rear side of the stopping face 124. A tab 321 is bent inwardly from a rear portion of the side wall 32 to lock with a concave 117 formed on a side wall of the upper cover 11. A pair of depressions 125 are formed on a bottom side of the main portion 12, and a pair of hooks 322 extend laterally and inwardly form a lower side of the side wall 32 to be secured in the depressions 125 respectively. A lower plate 122 projects forwardly from a lower portion of the base portion 12, and bottom wall 33 is supported by the lower plate 122.

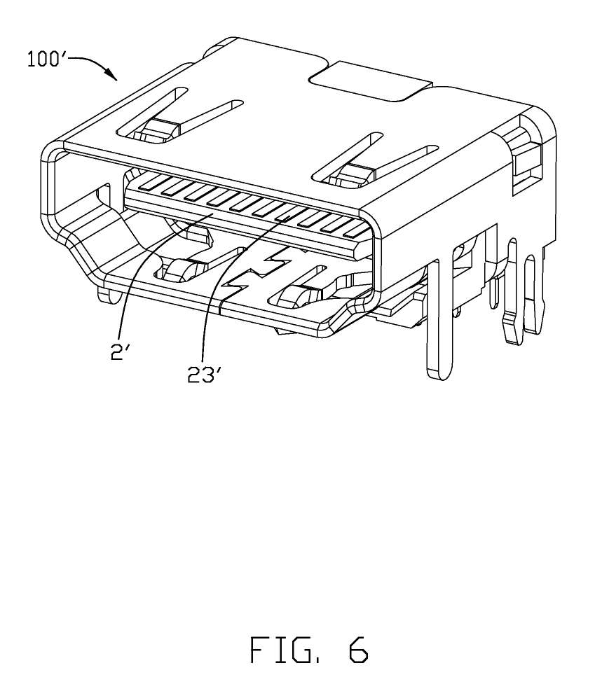

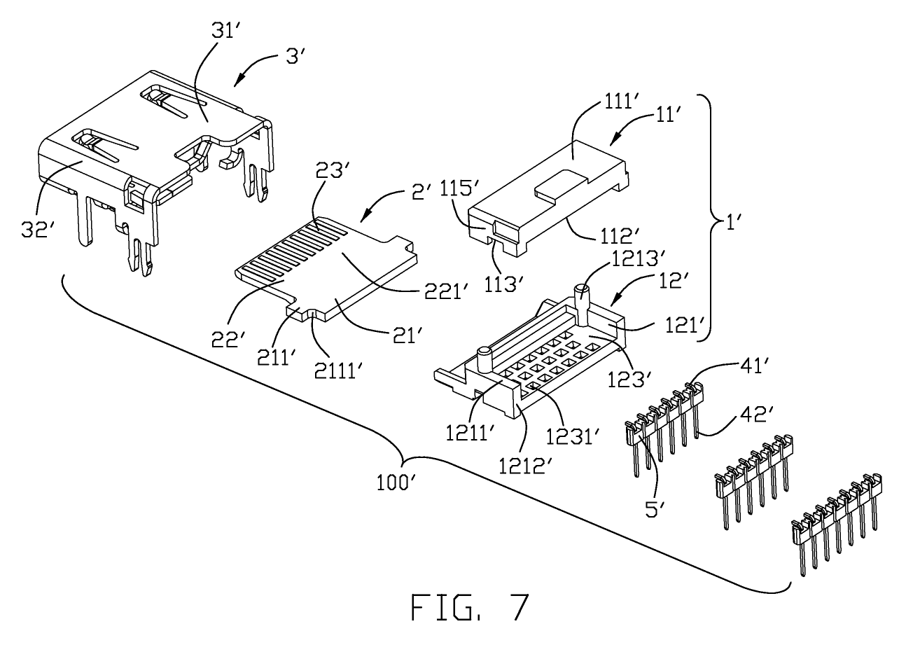

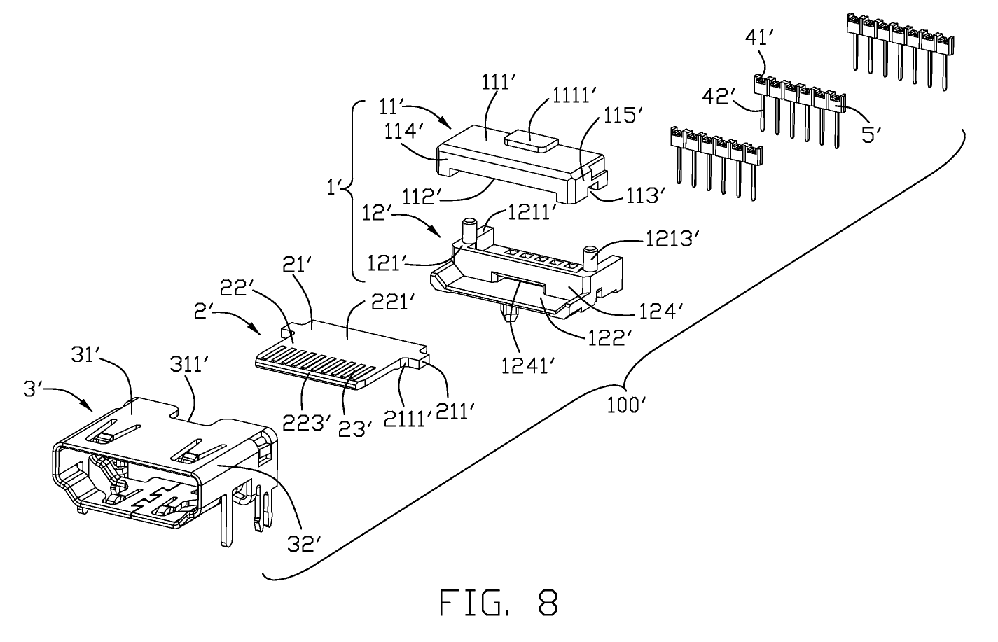

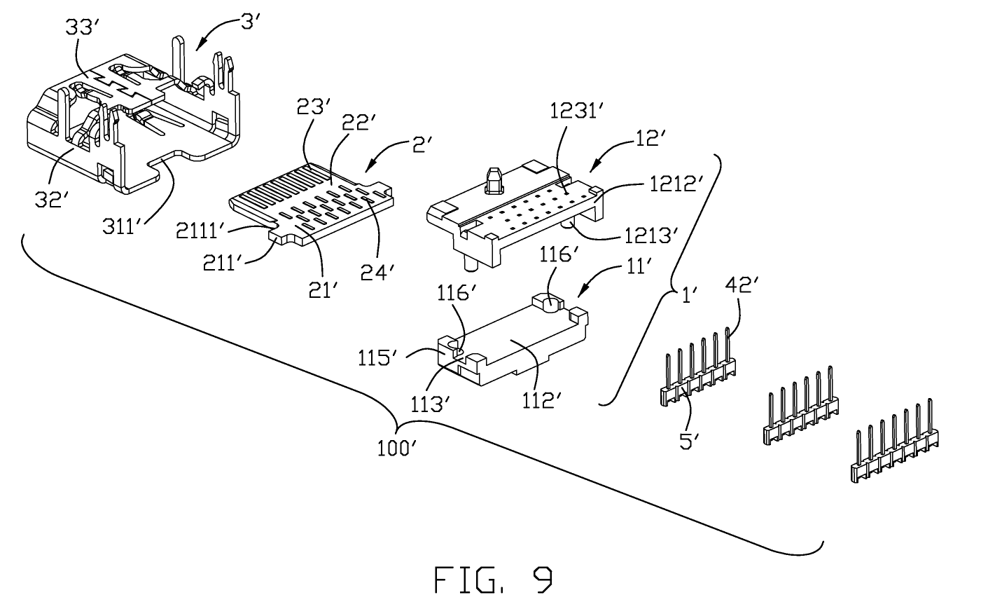

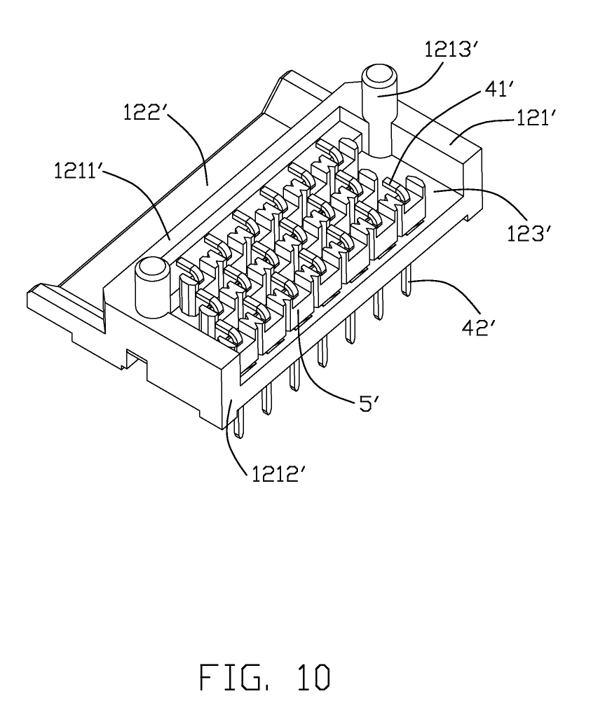

Referring to FIGS. 6-10, a second embodiment of the electrical connector 100′ is similar to the first embodiment shown in FIGS. 1-5, and differs in that the electrical connector 100′ is mounted onto the outer printed circuit board via through-hole technology, the second contacting pads 24′ are arranged in throw rows. The upper mating portion 41′ are also disposed in three rows. As shown in FIG. 7, the lower cover 12′ is provided with a lower plate 123′ on a rear side thereof to connect with the pair of arm portions 121′. The lower plate 123′ has three rows of through holes 1231′ to allow the soldering portions 42′ to penetrate therethrough. An insulative block 5′ is attached to a top end of the contact and be adjacent to the upper mating portion 41′. The insulative block 5′ and the corresponding contact constitute a contact module. The contacts are of right-angle. The insulative block 5′ is supported by the lower plate 123′. The upper mating portion 41′ and the insulative block 5′ is located between the supporting face 1211′ and the lower plate 123′.

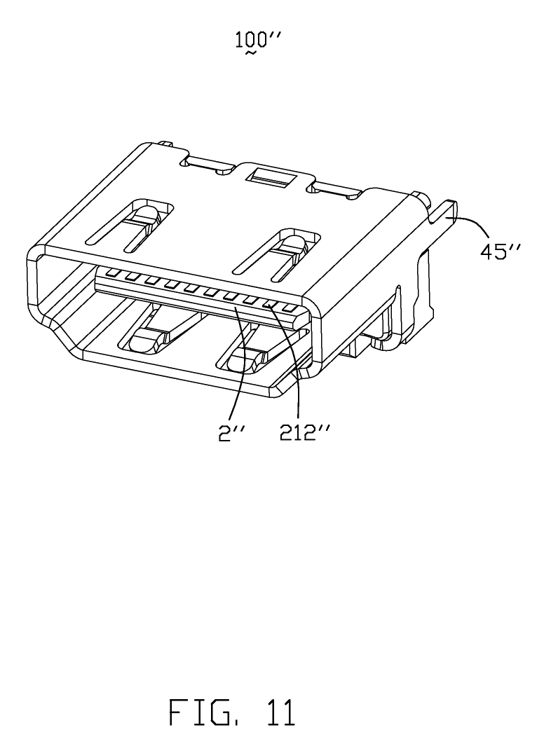

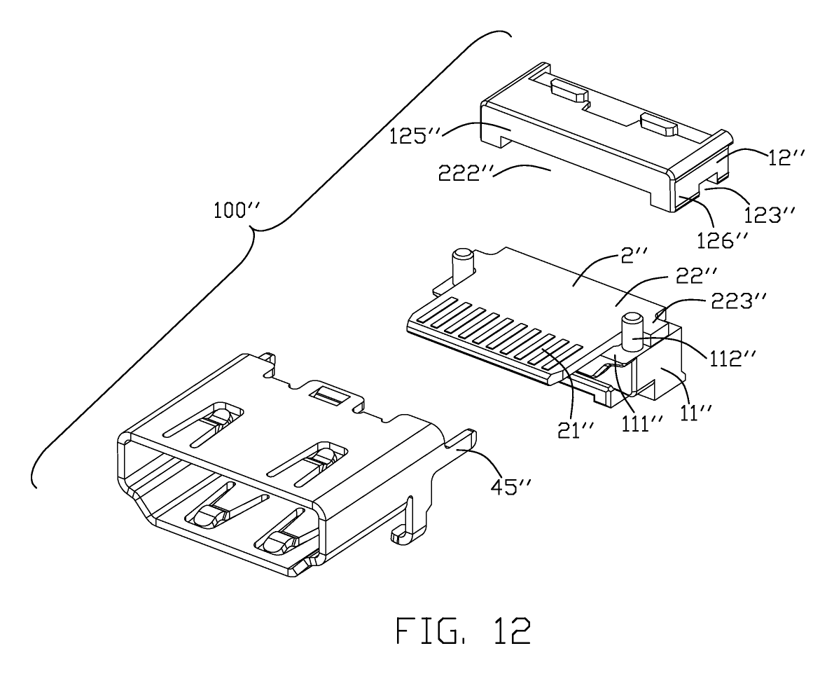

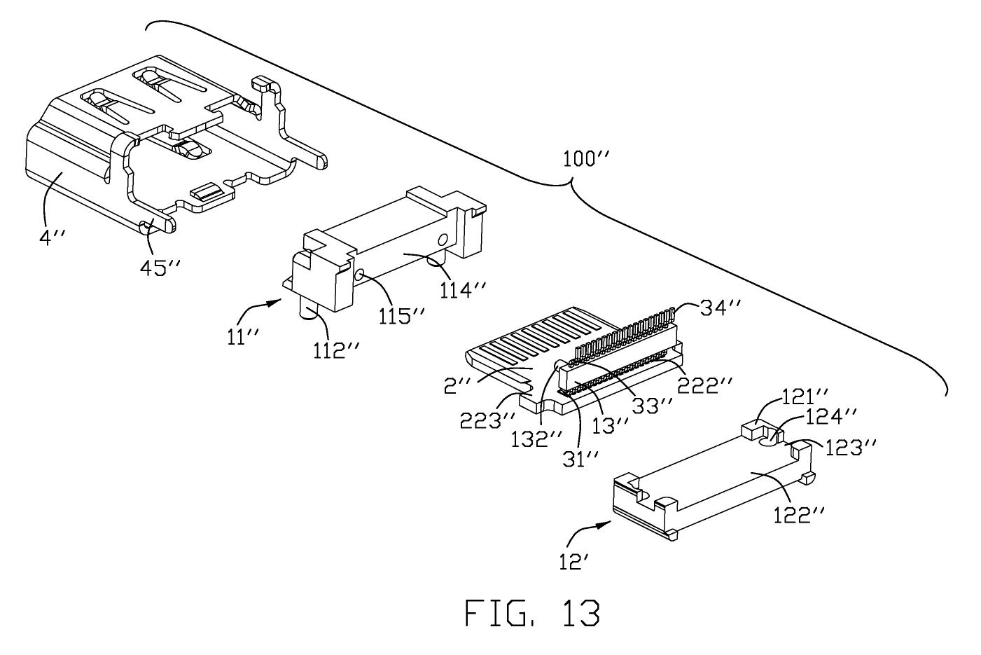

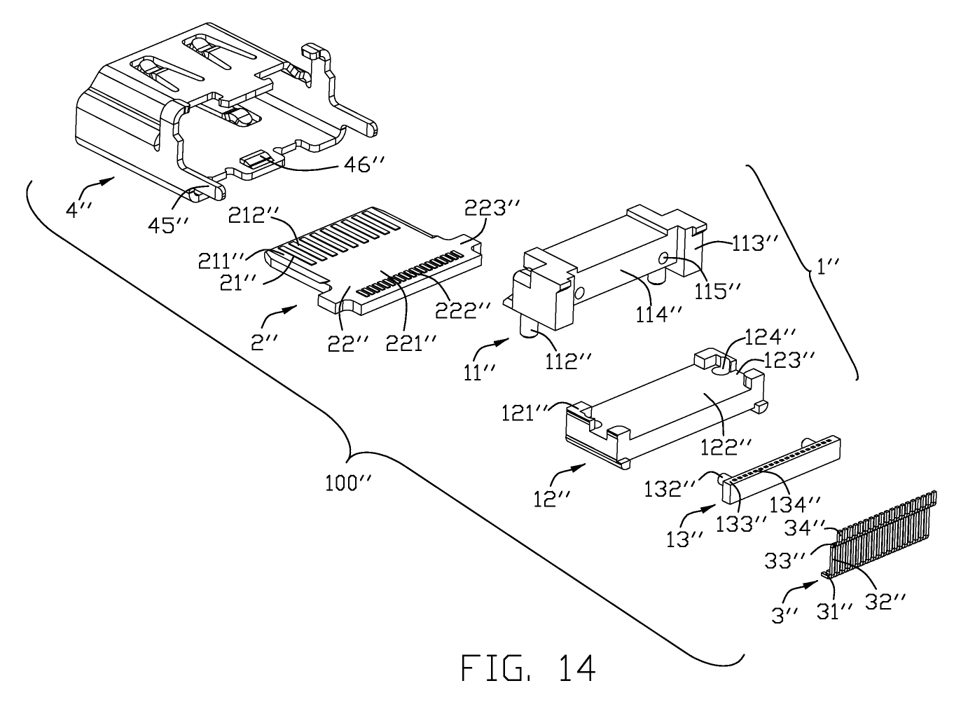

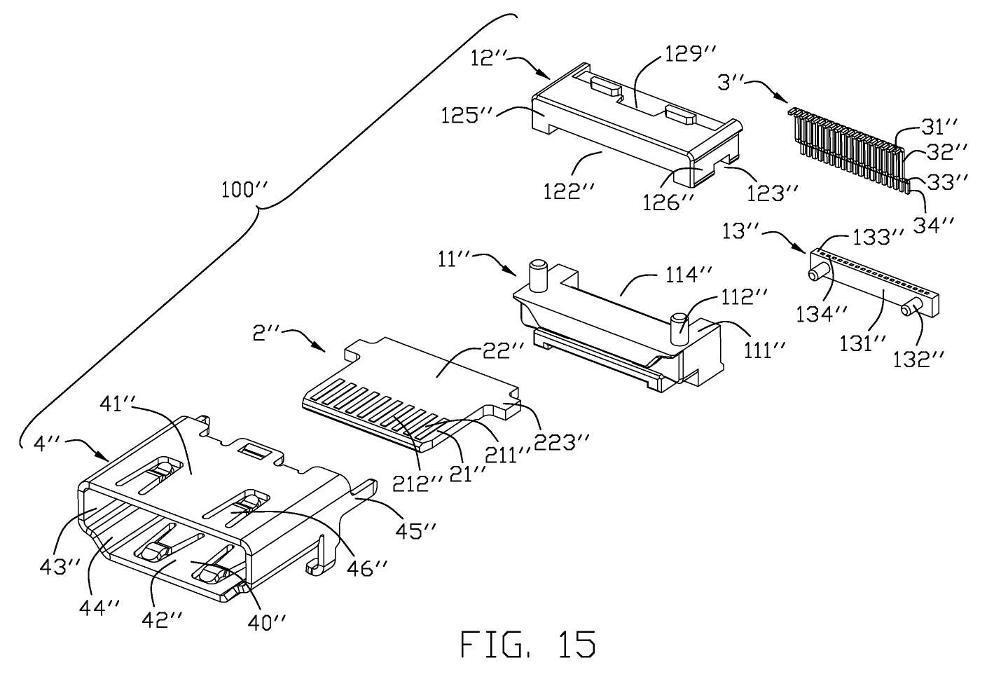

Referring to FIGS. 11-15, a third embodiment of the electrical connector 100″ is similar to the first embodiment shown in FIGS. 1-5, and differs in that the electrical connector 100″ is a vertical connector, that is to say, the inner printed circuit board 2″ is vertical to the outer printed circuit board. The shell 4″ is provided with a projection 46″ extending inwardly from a side wall thereof, correspondingly, the upper cover 12″ is formed with a cutout 129″ to lock with the projection 46″. The shell 4″ has a pair of soldering legs 45″ vertical to a stopping face 125″ of the upper cover 12″. The stopping face 125″ is adopted to abut against the mating plug to determine insertion length of the mating plug.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector to be mounted on an outer printed circuit board, comprising:
a receiving cavity to accommodate a mating plug;
an insulative housing including a lower cover which is provided with a rear base portion;
an inner printed circuit board being mounted onto the base portion and extending into the receiving cavity, and including a plurality of first contacting pads on a front side thereof to be exposed to the receiving cavity and a plurality of second contacting pads electrically connected to the first contacting pads respectively, the second contacting pads is to be electrically connected to the outer printed circuit board;
a plurality of contacts mounted to the second contacting pads respectively and to be mounted the outer printed circuit board;
a metal shell mounted onto the housing to enclose the insulative housing and the inner printed circuit board to form the receiving cavity, the metal shell being spaced apart from the inner printed circuit board.

2. The electrical connector as claimed in claim 1, wherein the shell includes an upper wall, a lower wall being parallel to the upper wall, and a pair of side walls connecting with the upper wall and the lower wall, the inner printed circuit board is parallel to the upper wall and the lower wall.

3. The electrical connector as claimed in claim 2, further comprising an insulative upper cover attached to the lower cover, the inner printed circuit board is sandwiched between the upper cover and the lower cover.

4. The electrical connector as claimed in claim 3, wherein the inner printed circuit board includes a rectangular portion with the first contacting pads and the second contacting pads formed thereon, and a rib projecting laterally and outward from a side edge of the rectangular portion, the upper cover has a hollow on a bottom side thereof to lock with the rib.

5. The electrical connector as claimed in claim 3, wherein the lower cover defines a supporting face to support the inner printed circuit board and a pair of first posts extending vertically and upwardly from the supporting face, and the upper cover is provided with a pair of first holes on a bottom side thereof to retain the first posts respectively.

6. The electrical connector as claimed in claim 4, wherein the upper cover comprises a pair of raised portions spaced apart from each other to form a slot therebetween, the slot extends through the upper cover along a front-to-rear direction, the rectangular portion is received in the slot and sandwiched between the raised portions along a transverse direction of the housing.

7. The electrical connector as claimed in claim 1, wherein the housing defines a first rear face, the inner circuit board includes a second rear face, both the first rear face and the second rear face lie in a same vertical plane.

8. The electrical connector as claimed in claim 3, wherein the upper wall of the shell abuts downwardly against a top side of the upper cover, a tab is bent inwardly from a rear portion of the side wall to lock with a concave formed on the upper cover.

9. The electrical connector as claimed in claim 2, wherein the shell includes a hook extending downwardly and inwardly from the side wall to lock with a recess formed on a lower side of the rear base portion.

10. The electrical connector as claimed in claim 1, wherein the electrical connector is a HDMI receptacle.

11. An electrical connector to be mounted on an outer printed circuit board, comprising:
a receiving cavity to accommodate a mating plug;
an insulative housing including a rear base portion;
an inner printed circuit board mounted onto the base portion, and including an upper face, a lower face opposite to the upper face, a plurality of first contacting pads on a front side thereof to be exposed to the receiving cavity and a plurality of second contacting pads electrically connected to the first contacting pads respectively, the first contacting pads are arranged in an upper row on the upper face and a lower row on the lower face, the second contacting pads are arranged only on the lower face;
a plurality of contacts mounted to the second contacting pads respectively and being configured to be mounted the outer printed circuit board.

12. The electrical connector as claimed in claim 11, further comprising a metal shell mounted onto the housing to enclose the insulative housing and the inner printed circuit board to form the receiving cavity, the metal shell is spaced apart from the inner printed circuit board.

13. The electrical connector as claimed in claim 12, wherein the second contacting pads are arranged in three rows.

14. The electrical connector as claimed in claim 12, wherein the housing includes an insulative upper cover and a lower cover attached to the upper cover, the inner printed circuit board is sandwiched between the upper cover and the lower cover, the rear base portion is formed on the lower cover.

15. The electrical connector as claimed in claim 14, wherein the inner printed circuit board includes a rectangular portion with the first contacting pads and the second contacting pads formed thereon, and a rib projecting laterally and outward from a side edge of the rectangular portion, the upper cover has a hollow on a bottom side thereof to lock with the rib.

16. The electrical connector as claimed in claim 14, wherein the rear base portion defines a vertical stopping face to abut against a front end of the mating plug and determine an insertion length of the mating plug, the first contacting pads are arranged in a front side of the stopping face, the second contacting pads are located on a rear side of the stopping face.

17. An electrical connector assembly for mating with a complementary connector, comprising:
an exterior printed circuit board;
an electrical connector mounted upon said exterior printed circuit board, said connector including:
an insulative housing enclosed in a metallic shell with a receiving port in said shell and in front of said housing;
an interior printed circuit board retained by said housing and spaced with the exterior printed circuit board in a parallel relation, said interior printed circuit board defining opposite upper and lower surfaces thereon;
a plurality of front circuit parts formed on both said upper surface and lower surface for mating with said complementary connector; and
a plurality of rear circuit parts formed on at least one of said upper surface and said lower surface to mechanically and electrically connect to a plurality of contacts, respectively, which are mounted to the exterior printed circuit board.

18. The electrical connector assembly as claimed in claim 17, wherein said housing defines an upper cover and a lower cover sandwiching said interior printed circuit board therebetween.

19. The electrical connector assembly as claimed in claim 18, wherein complementarily interengaging structures including a rib and a hollow are formed the interior printed circuit board and at least one of said upper cover and said lower cover.

20. The electrical connector assembly as claimed in claim 17, wherein said contacts are arranged with at least two rows in a front-to-back direction, and said rear circuit parts are formed only on the lower surface with at least two rows in said front-to-back direction.
